(19) United States
(12) Patent Application Publication
(10) Pub. No.: US 2004/0158587 A1
(43) Pub. Date: Aug. 12, 2004

(54) Computer implemented method for controlling document edits

(75) Inventors: James R. Shay, Seattle, WA (US); Jeffry J. Grainger, Portola Valley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First to File, Inc, Menlo Park, CA

(21) Appl. No.: 09/997,311

(22) Filed: Nov. 27, 2001

Related U.S. Application Data
(60) Provisional application No. 60/309,244, filed on Jul. 31, 2001.
(60) Provisional application No. 60/253,360, filed on Nov. 27, 2000.

(51) Int. Cl. G06F 17/30

(52) U.S. Cl. 707/201

(57) ABSTRACT

The method of the present invention simplifies and streamlines the tasks that must be carried out in order to prepare and control electronic documents such as patent applications. In one embodiment, the computer-implemented method of the present invention includes storing a plurality of alterable electronic documents on a computer system, the plurality of electronic documents being associated with a patent application, generating a first signal indicating that one or more of the electronic documents are to be filed to a patent office, and automatically locking the one or more electronic document so that the documents cannot be altered. In another embodiment, electronic documents may be associated with a package and automatically locked when a user transmits a signal indicating that the package has been transferred from a first phase to a second phase.

### CROSS-REFERENCES TO RELATED APPLICATIONS

This application claims the benefit of commonly-owned U.S. Provisional Application No. 60/253,360, filed Nov. 27, 2000, entitled “DATA PROCESSING SYSTEM FOR MANAGING INTELLECTUAL PROPERTY ASSETS,” listing Jeffry J. Grainger as inventor, which is hereby incorporated herein by reference in its entirety. This application also claims the benefit of commonly-owned U.S. Provisional Application No. 60/309,244, filed Jul. 31, 2001, entitled “COMPUTER IMPLEMENTED METHOD FOR CONTROLLING DOCUMENT EDITS,” listing James R. Shay and Jeffry J. Grainger as inventors, which is also hereby incorporated herein by reference in its entirety.

This application is related to commonly-owned U.S. application Ser. No. 09/872,764, filed Jul. 31, 2001, entitled “USER INTERFACE FOR MANAGING INTELLECTUAL PROPERTY,” listing Jeffry J. Grainger as inventor, the disclosure of which is hereby incorporated herein by reference in its entirety. This application is also related to commonly-owned and concurrently filed U.S. application Ser. No. ______ (Attorney Docket No. 020313-000710US), filed Nov. 27, 2001, entitled “METHOD OF DEFINING WORKFLOW RULES FOR MANAGING INTELLECTUAL PROPERTY,” listing Jeffry J. Grainger as inventor, the disclosure of which is hereby incorporated herein by reference in its entirety.

### BACKGROUND OF THE INVENTION

The present invention relates to managing intellectual property. More particularly, the present invention relates to a computer-implemented method of controlling document edits in a system for obtaining and maintaining intellectual property rights such as patent rights.

As the world economy has become more information and technology oriented, patents and other intellectual property are of growing importance. In order to secure such intellectual property rights appropriate paperwork needs to be completed and filed in an intellectual property office. For example, in order to secure patent protection within the United States, a patent application describing and claiming an invention needs to be filed in the United States Patent and Trademark Office (hereinafter “USPTO”). Once filed, previously established rules and guidelines are followed by a Patent Examiner to determine whether or not patent rights to the invention should be granted. Typically, the process for obtaining these rights includes communications between the patentee and the patent office with many of such communications requiring a response within a given time period.

FIG. 1 is a diagram that illustrates a typical sequence of events and exchanges that occur between technology developers 2 and a Patent Office 6, such as the USPTO, in order to secure protection for a patent application. Also shown in FIG. 1 are patent attorneys and/or patent agents 4 (hereinafter referred to collectively as “practitioners”) that often represent technology developers 2 in patent procurement process along with their administrators. As used herein, technology developers are inventors, corporations and other entities that generate inventions and other ideas to be turned into patent applications (i.e., the intellectual property creators). Also, a “patent office” is any patent office designated to receive patent filings for an individual country or collection of countries as provided for by various treaties or other compacts that countries may enter. Examples of patent offices include but are not limited to the United States Patent and Trademark Office, the European Patent Office, the German Patent Office, the Japanese Patent Office and any designated receiving office for patent applications filed under the Patent Cooperation Treaty.

As shown in FIG. 1, the patent process typically starts with the communication of an idea (invention) from a technology developer 2 (sometimes referred herein to as “Applicant”) to a practitioner 4. Such an idea is often communicated to practitioner 4 in the form of a written invention disclosure 10. The practitioner then prepares a patent application 12 that is filed in the USPTO. After the application is received by the USPTO and it is verified that all the necessary papers have been correctly completed, the application is examined by a qualified patent examiner (hereinafter the “Examiner”). The Examiner then prepares and sends an Office Action 14 to practitioner 4. The Office Action sets forth the USPTO's initial opinion on the patentability of the invention (of course, other papers, such as a Restriction Requirement or Notice of Allowance, may be prepared and sent instead of an Office Action as appropriate).

Practitioner 4 reports receipt of the Office Action to technology developer 2 by sending a Notification 16 that often summarizes key issues in the Office Action. In some instances, Applicant then prepares Instructions 18 to practitioner 4 so that the attorney may prepare and file an appropriate Response 20. This Office Action 14/Response 20 cycle may be repeated one or more times until the Examiner mails a Notice of Allowance 22 to practitioner 4 indicating the patent application is in condition for allowance or the case is abandoned. If allowed, practitioner 4 mails a Notification 24 of the Allowance to Applicant 2 who provides Instructions 26 to practitioner 4 to transmit the Issue Fee 28 to the Patent Office. Several months after the Issue Fee is paid an Issued Patent 30 is published. U.S. Patent Law requires Maintenance Fees to be paid on an issued patent 3½, 7½ and 11½ years after issuance to maintain the patent in force. Attorneys 4 typically send Fee Reminders 32 to Applicants 2 about such maintenance fees. Applicants respond with Instructions 34 to ensure that Fees 36 are paid in a timely fashion.

FIG. 1 is just a brief overview of the patent process, however. In many instances there are numerous other communications and exchanges between the inventor and attorney, between the in-house attorney and outside attorney and between a foreign attorney or agent and prosecuting attorney or agent that are not shown in FIG. 1. Also, the communications shown in FIG. 1 pertain to obtaining patent protection in a single country. As can be appreciated, obtaining protection for a patent application in multiple countries, i.e., prosecuting the application to issuance and paying necessary annuity and maintenance fees, involves many more communications between applicants, practitioner 4 and the Patent Office and may also include communications between an additional practitioner 4 that specializes in patent protection for the particular country. Accordingly, there may be well over a hundred separate communications/transactions between the applicant or inventor, attorneys and/or patent agents and the various patent offices for a single patent application.

Accurately tracking all the various communications and papers associated with a patent filing so that, when needed, such communications and papers can be retrieved in a timely manner is an important aspect of managing an intellectual property portfolio. Typically, patent filers keep paper-based files, one for each patent application in each individual country that protection is sought, that store and organize all such communications and papers. Law firms and corporations have devised a number of different approaches for organizing such files. For example, some law firms use trifold files and keep communications between the client and attorney on the left side of a folder, papers filed in or received from the Patent Office in the center portion of the file and miscellaneous other papers (e.g., copies of the application as filed and/or figures) on the right side of the file. While such file organization methods have served well in the past, it is desirable in some instances to do away altogether with paper-based files and move to a more electronic or “paperless” approach. Accordingly, a graphical user interface that enables a user to quickly and efficiently access documents and other information stored electronically and associated with a selected patent application is desirable.

A further problem related to a paper based system is that individual papers can become separated from the files. In the case of a patent application or office action, this can lead to an incomplete record of the materials that have been submitted to the patent office. Additionally, when using paper based systems, there is a risk that versions of documents may become mixed up or lost altogether. For example, there is a risk that a preliminary version of a patent application or response and amendment to an office action may mistakenly be filed in place of the final version. This can lead to a severe impact on the value of the ultimate patent that issues, especially if the error is not discovered. Thus, a method of controlling document edits in an electronic patent document management system would also be desirable.

### SUMMARY OF THE INVENTION

Embodiments of the present invention solve the problems described above with respect to previously known methods of controlling document edits in an electronic document management system. Specifically, the present invention provides a computer-implemented method of controlling document edits for electronic documents to be submitted to a patent office.

In one embodiment, the computer-implemented method of the present invention includes storing a plurality of alterable electronic documents on a computer system, the plurality of electronic documents being associated with a patent application, generating a first signal indicating that one or more of the electronic documents are to be filed to a patent office, and automatically locking the one or more electronic document so that the documents cannot be altered.

In one embodiment, the computer-implemented method of the present invention includes storing a plurality of alterable electronic documents on a computer system, the plurality of electronic documents being associated with a patent application, creating a package including one or more of the electronic documents, the package being displayed in a first folder of a graphical user interface, and automatically locking down the one or more electronic documents in the package when a user transmits a first signal indicating that the package has been transferred from a first phase to a second phase.

In another embodiment, the computer-implemented method of the present invention includes storing a plurality of electronic documents on a computer system, each electronic document having a native format type, creating a package including one or more of the electronic documents, generating a first signal indicating that package is ready to be filed in a patent office, automatically transforming the one or more electronic documents from its native format types into a format type that is viewable exactly as it will be printed, and displaying the transformed one or more documents to a remote user.

These and other embodiments of the present invention, as well as its advantages and features, are describe in more detail in conjunction with the text below and attached figures.

### BRIEF DESCRIPTION OF THE DRAWINGS

FIG. 1 is a diagram that illustrates a typical sequence of events involved in filing a patent application in an Patent Office, such as the United States Patent and Trademark Office;

FIG. 2 is a simplified block diagram showing the relationship between an intellectual property data processing system according to one embodiment of the present invention and participants in the patent process;

FIGS. 3A-3C are exemplary Web pages generated by IP data processing system according to one embodiment of the present invention;

FIG. 4 is an exemplary Web page that illustrates one embodiment of a trifold graphical user interface according to the present invention;

FIGS. 5-6 are additional exemplary Web pages generated by IP data processing system according to certain embodiments of the invention;

FIG. 7 shows a flow chart illustrating a method of controlling document edits according to one embodiment of the present invention;

FIG. 8 is another exemplary Web page that illustrates controlling document edits in a trifold graphical user interface according to one embodiment of the present invention; and

FIG. 9 illustrates a method of controlling document edits according to another embodiment of the present invention.

### DESCRIPTION OF THE SPECIFIC EMBODIMENTS

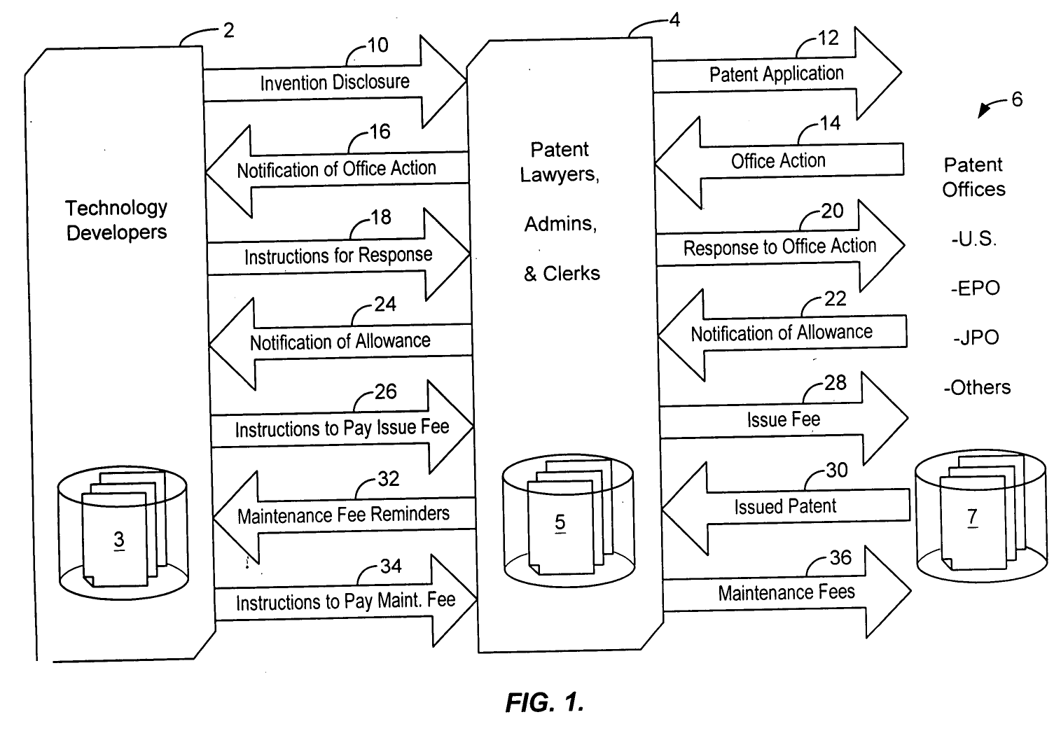

The present invention provides a novel and useful interface and document control system that provides quick and easy access and control of the various communications and documents associated with a patent application. The interface and document control system can be generated from, among other possibilities, a computer program that executes on a stand-alone computer or a computer server in a distributed computer network. For convenience, the description of one embodiment of the interface and document control system are set forth below with respect to an application service provider (ASP) model that communicates with client systems over the Internet. In this ASP model, an intellectual property data processing system 100 converts the paper-based patent prosecution system described with respect to FIG. 1 into an electronic workflow pipeline that allows every step in the process to be executed from a computer desktop. One of ordinary skill in the art would recognize other variations, modifications and alternatives to this embodiment. Accordingly, the ASP system described below is not intended to limit the scope of the invention in any way.

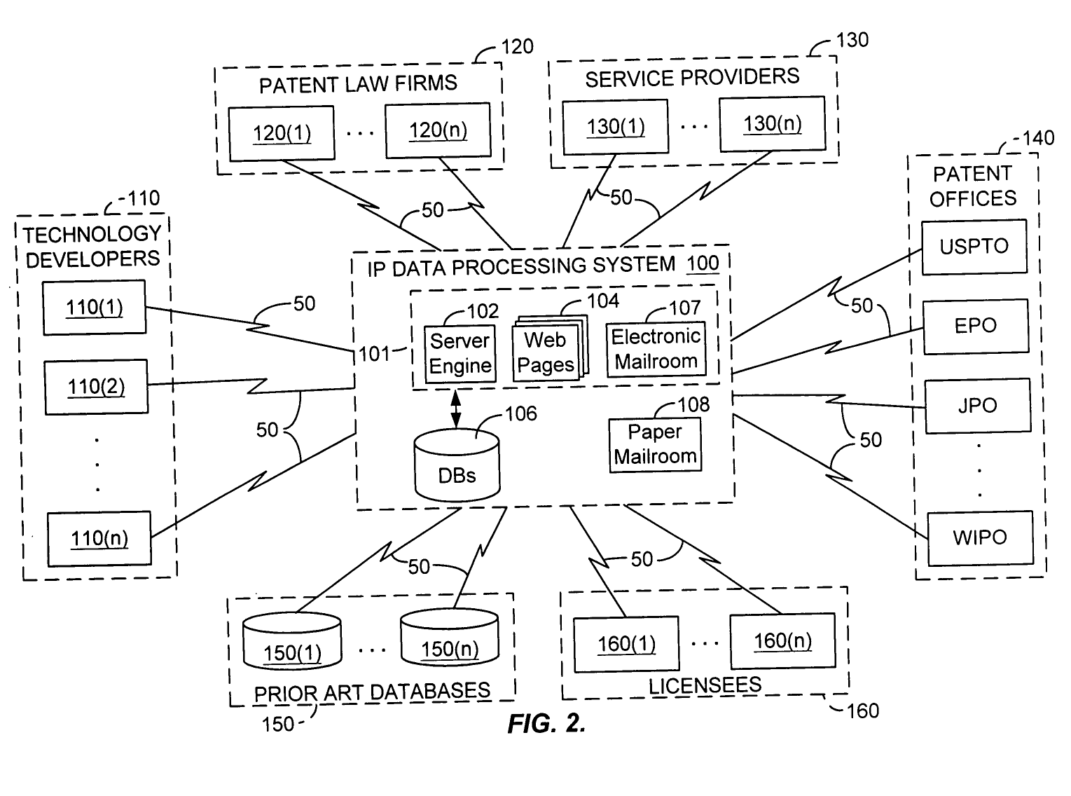

FIG. 2 is a simplified block diagram showing the relationship between an intellectual property (IP) data processing system 100 according to one embodiment of the present invention and participants in the patent process. IP data processing system 100 is a Web-enabled electronic platform that can be utilized by all participants in the patent process.

The participants shown in FIG. 2 include technology developers 110, patent law firms 120, service providers 130, patent offices 140, prior art databases 150 and potential licensees 160. For convenience, each of these participants is referenced by a dotted line that encompasses individual entities of the participant type. For example, technology developers 110 are shown in FIG. 2 as including individual technology developers 110(1), 110(2) through 110(n). It is to be understood that, while shown in FIG. 2 as a group, these multiple technology developers are separate entities that likely have no relation to each other than their classification within this patent application as developers of technology. It is also to be understood that, while not shown, each individual participant system typically includes its own firewall system that implements access control functions to isolate the system from unwanted intrusions by others.

Each of the participants shown in FIG. 1 can communicate and exchange information through Internet 50. A person of ordinary skill in the art would recognize that in other embodiments the participants may communicate and exchange information using other communication network mediums including a local or wide area network (LAN or WAN), a wireless network, an intranet, a virtual private network and the like.

Technology developers 110 include corporations, universities and individual inventors seeking to file patent applications and receive issued patents. Patent law firms 120 include U.S. patent attorneys, patent agents and foreign patent attorneys and/or agents. Service providers 130 include patent draftsman, prior art search companies, translation companies and other entities that provide services useful to the patent process as well as financial institutions and other parties that have tangential roles in the process. Prior art databasew 150 include public and licensed private databases, such as online patent databases (e.g., issued U.S. patents, published European and Japanese patents, etc.) and non-patent databases. Patent offices 140 include patent offices worldwide including the USPTO, the European Patent Office (EPO), the Japanese Patent Office (JPO), the Taiwanese Patent Office, etc.

Processing system 100 provides technology developers 110 and their associated patent law firms 120 a highly secure, central data repository that can be shared between participants on an as-allowed basis. Information generated and used during the patent prosecution process can be shared between a technology developer 110 and appropriate patent law firm(s) 120 and service provider(s) 130 in order to create patent filings, prosecute such filings through issuance and then subsequently maintain patent rights after grant.

As shown in FIG. 2, IP data processing system 100 includes a Web server 101, a database 106 and paper mailroom 108. Web server 101 includes a server engine 102 that generates and sends graphical documents including Web pages 104 to client systems as requested and an electronic mailroom 107. As used herein, a “client system” is a computer system that displays Web pages generated by server engine 102, e.g., through a browser residing on the client system. Thus, technology developers 110, patent law firms 120, service providers 130 and licensees 160 typically include one or more client systems. For example, a large corporation (technology developer) may have 150 inventors, 4 patent administrators and 2 in-house practitioners. Each of these individuals likely has their own computer system and can thus become a client system. Specific categories of client systems are also sometimes referred to herein. For example, an “inventor client system” is any client system associated with an inventor from one of the technology developers 110. Similarly, an “in-house client system” is any client system associated with a patent attorney, patent agent, patent administrator, secretary or other employee or contractor of a technology developer other than an inventor that has rights to create, edit or view information related to patent applications owned by the technology developer. An “outside representative client system” is an outside patent attorney, patent agent, patent administrator, secretary or other employee or contractor associated with a patent law firm 120 that represents a particular technology developer.

Each client system can display the Web pages generated by server engine 102. Each of such Web pages is uniquely identifiable by a Uniform Resource Locator (URL) and is stored in a computer-readable memory (not shown) accessible to the server engine. To view a specific document, including a Web page, a client system uses a Web browser executing on the client system to specify the URL for the document in a request (e.g., a HyperText Transfer Protocol “HTTP” request) as is known to those of skill in the art. The request is forwarded to the Web server supporting the document (server system 101 in this instance), which when it receives the request, sends the requested document to the client system. The Web browser may then display a Web page contained in the document, e.g., HTML document.

Database 106 stores information pertaining to the technology developers' intellectual property portfolios. Patent process participants (such as technology developer employees and outside law firm personnel) access this information as needed and only to extent that their access rights permit. The information in database 106 includes draft and completed invention disclosures, draft and completed patent application documents; draft and completed amendments; messages and discussions pertaining to invention disclosures and patent applications; patent and patent application status information; prior art publications; office actions, assignment papers and other forms and papers filed in or generated by a patent office; etc. As described in detail below, much of this information for an individual patent application is easily accessible to a user through a user interface utilized in embodiments of the present invention.

IP data processing system 100 communicates with patent offices 140 over Internet 50 through electronic mailroom 107 and through standard snail mail (e.g., U.S. Postal Office Express Mail) using paper mailroom 108. For such communications in some embodiments, system 100 sets the correspondence address to mailroom 107 or 108 so that replies to the communications can be tracked and entered into database 106 as described below.

Electronic mailroom 107 is part of server 102 and includes a suite of programs that interface to the standards set by each patent office 140. For example, in order to file patent applications electronically through the USPTO the system comports to the standards required by the USPTO's Electronic Filing System (EFS). This includes using the Electronic Packaging and Validation Engine (ePAVE) or compatible software to facilitate electronic filing. Complete details of the ePAVE software are available online through the USPTO's Electronic Business Center Web site at http://www.uspto.gov/. Also, in order to track and update status information for pending patent applications, such as Examiner name, assigned art unit and class/subclass, etc., electronic mailroom 107 has the ability to interface to the USPTO's Patent Application Information Retrieval (PAIR) system using appropriate digital certificates. Electronic mailroom 107 also includes other programs to interface with other patent offices.

Paper mailroom 108 includes printers, fax machines and other appropriate equipment to carry out all the duties necessary to file patent applications and other formal papers in patent offices using standard mailing procedures. Paper mailroom 108 also includes scanners and equipment necessary to scan papers received from technology developers 110, practitioners 120 and patent offices 140 into computer-readable format. Such correspondence is scanned and analyzed by optical character recognition (OCR) software to create two versions of the document: an image version and a text version created by the OCR software. The image version is stored for archival purposes. The OCR software is calibrated to recognize particular fields within common patent office forms to capture data from those forms so that appropriate data (e.g., due dates, Examiner's name, Applicant, application no., etc.) from such papers can be parsed and entered into database 106. To this end, the fields of various patent office forms that are scanned by mailroom 108 are mapped to database 106 along with the document type (determined from the form recognition sequence) in order to enable the system to determine the appropriate docketing deadlines. Alternatively, or in addition to such scanning, personnel in mailroom 108 can directly enter appropriate data into database 106 using computers or data entry terminals coupled to the database through a local area network or similar network. Once scanned into computer-readable format, communication between IP data processing system 100 and technology developers 110 can proceed in a manner that, from the standpoint of a technology developer, seems entirely paperless.

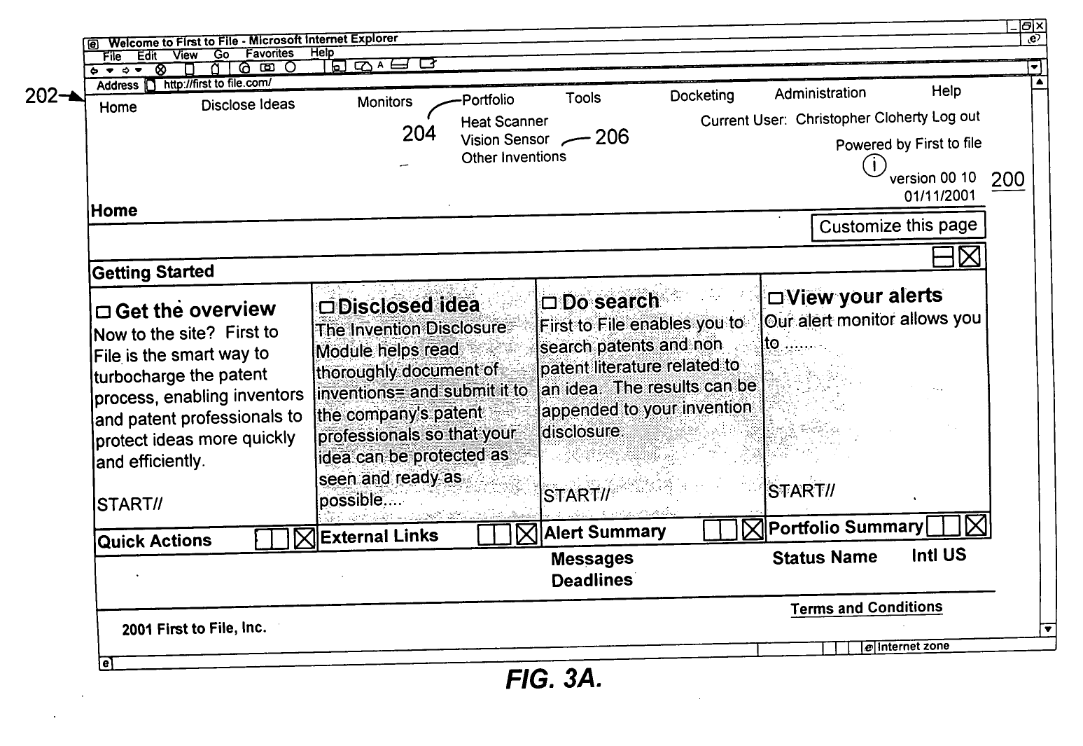

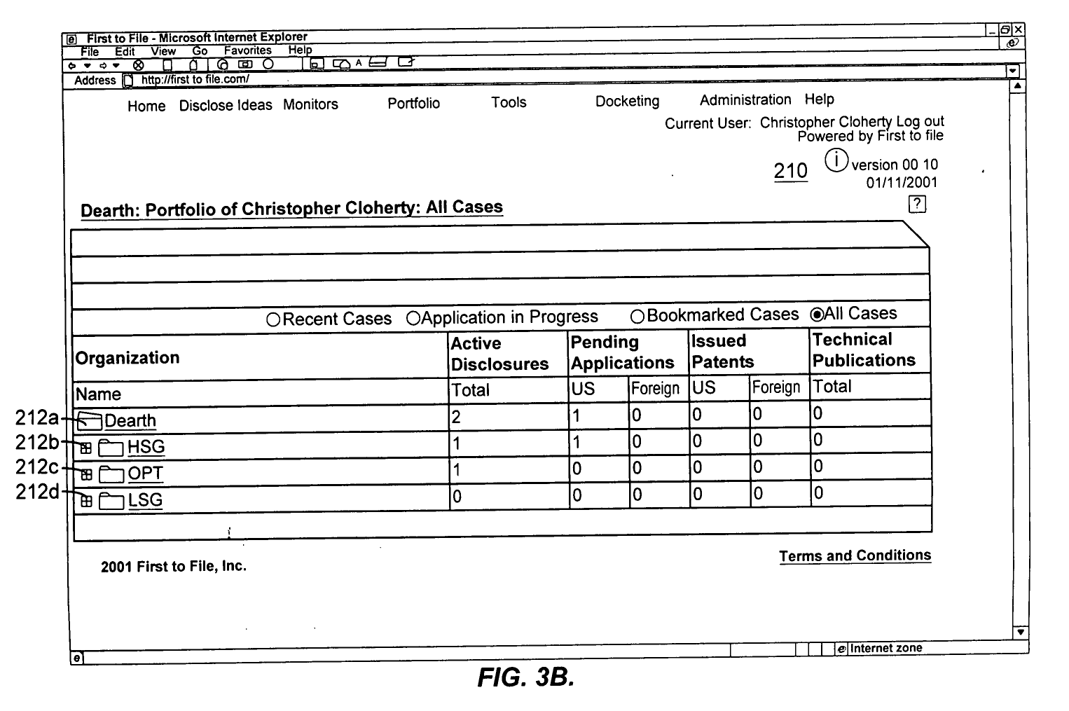

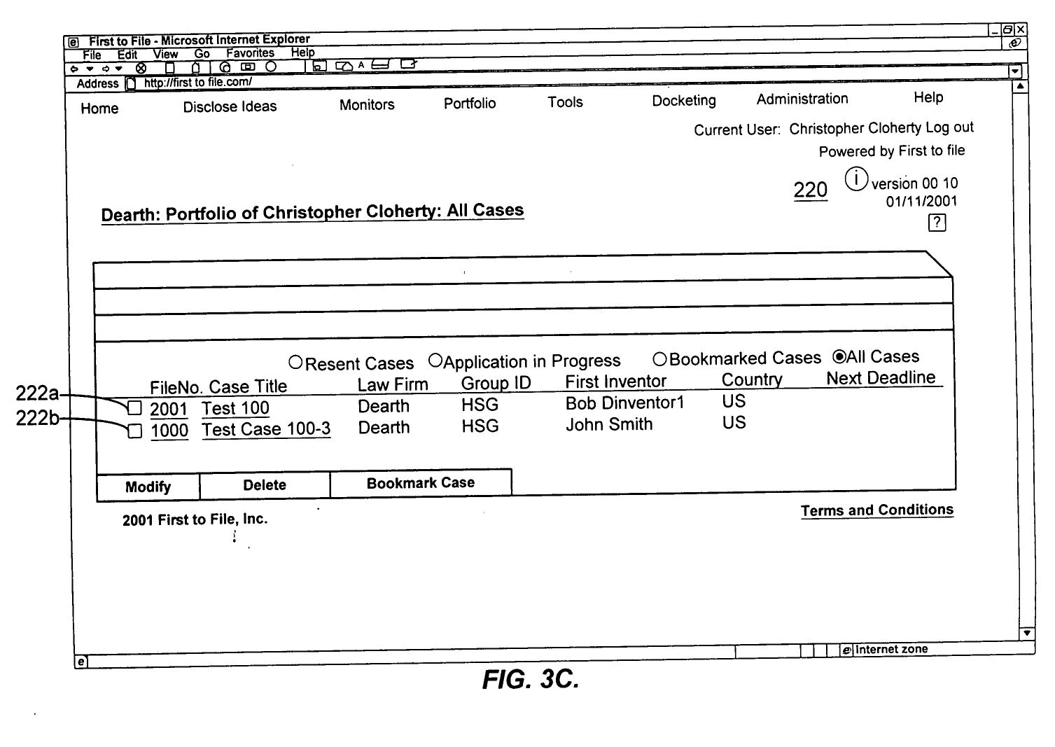

FIG. 3A is an example of a Web page 200 that may be the home page for an outside representative client system at a patent law firm 120(i) or for an in-house client system at a technology developer 110(i) among other client systems. Web page 200 provides appropriate client systems with quick access to reporting capabilities that enable a “big picture” view of a company's or client's IP assets. As shown in FIG. 3, one such reporting capability is accessible through a navigation menu 202 by selecting a “view cases” menu selection 206 under a portfolio entry 204 in the menu bar.

Upon selecting the “view cases” menu selection 206, for example by double clicking on the selection, the client system is presented with a Web page 210 (FIG. 3B) that provides access to each patent application file the client system has access rights to view. Links labeled as file numbers and/or patent application titles to each patent application file may be directly accessible on page 210 or the links may indirectly accessible through other links, e.g., a package or a file folder. For example, if the viewing client system is an outside attorney, there may be a folder for each client the attorney represents with each client file folder containing one link to each patent application the attorney is responsible for that client. The client system viewing Web 210 in this example, however, is an in-house client system and, as shown in FIG. 3B, displayed on page 210 are four folders 212a-212d. Folder 212a represents cases assigned to a particular outside fictional company, Dearth. Folders 212b-212d are actually folders within folder 212a and represent company divisions within Dearth. Folders such as folders 212a-212d may contain links (not shown in FIG. 3B) to the individual patent files of each division. FIG. 3C is an exemplary Web page 220 that shows links 222a and 222b to two individual patent files within the HSG (Health Solutions Group) group folder 212b shown in FIG. 3C.

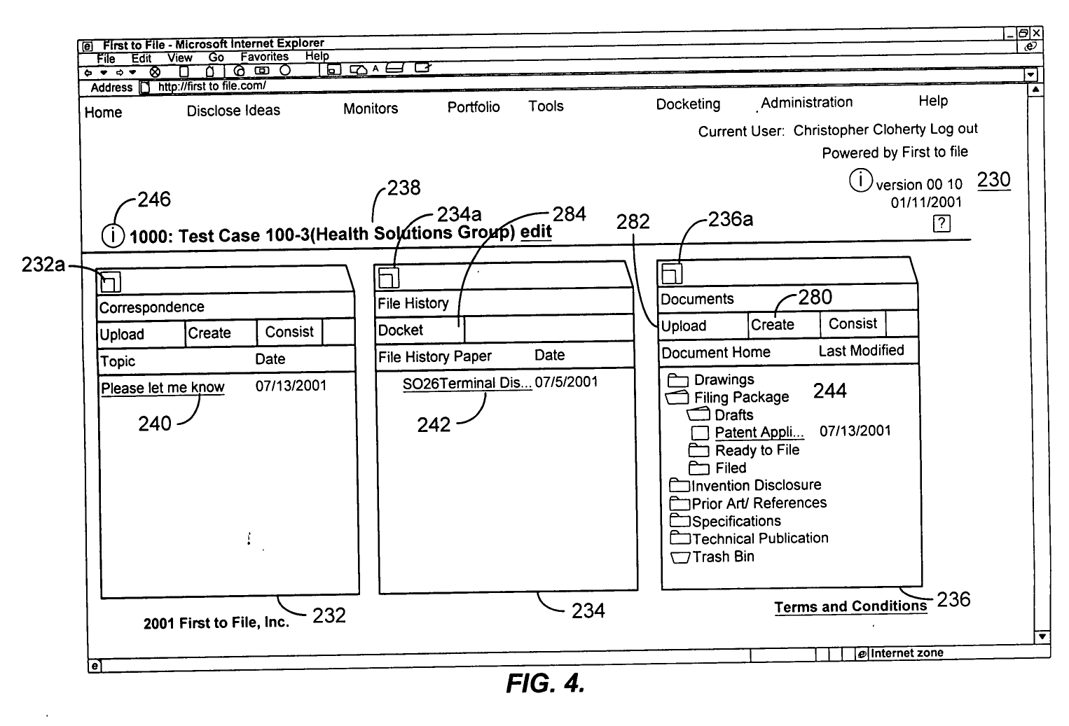

Each link 222a and 222b is selectable under either the unique file number associated with the patent file or by the patent file's title. Once selected, a graphical user interface according to the present invention is displayed that provides the client system quick and easy access to various communications and documents associated with the patent application. FIG. 4 shows an exemplary Web page 230 according to one embodiment of a trifold graphical user interface that provides the client system access to communications and documents associated with a patent application. Web page 230 emulates the look and feel of an actual trifold paper file that is used by some law firms and corporations to organize patent documents.

As shown in FIG. 4, there are four primary display sections on Web page 230. These include correspondence section 232, file history section 234, document section 236 and case summary section 238. Correspondence section 232 displays a list of all correspondence between the outside and in-house attorneys, patent administrators and inventors for the selected patent matter (“Test Case 100-3” of the “Health Solutions Group” in this particular example). Entry 240 in correspondence section 232 is an html link that leads to the underlying correspondence document. Thus, to view an individual correspondence document in section 232, the user of the client system simply selects the link associated with the desired correspondence document. Similarly, each of the documents shown in file history section 234 and document section 236 are also html links to underlying documents. Correspondence documents can be email messages, word processing documents, scanned image files as well as other types of documents. Rather than leading directly to the document in all cases, some of these links may represent a package, or collection of documents, and when selected a Web page is displayed that shows the contents of the package, i.e., the list of documents in the package.

A person of skill in the art will recognize that selection techniques other than html links may be used in other embodiments of the invention, for example, in some alternative embodiments, entry 240 and other document identifiers in sections 234 and 236 are filenames that can be selected to obtain the underlying document. As used herein, the term “file link” is used to generically represent something selectable by a user to access an underlying document either directly (e.g., if the file link is a selectable hypertext link to the document or a selectable document filename in a Windows or other computing environment) or indirectly (e.g., if the file link is a selectable hypertext link to a page displaying hypertext links to multiple, associated documents or a selectable folder or package in a Windows or other computer environment that contains one or more documents). Documents include email messages, files stored in image format, files stored in a format associated with an application (e.g., word processing files), forms, and the like.

File history section 234 lists all the official papers that have been sent to and received from the patent office. These documents (referred to as “patent documents” herein) are stored in an image format (e.g., .pdf, .bmp or .tiff file formats). The image format preserves the actual look of any paper documents that were either transmitted to a patent office in paper format or received from a patent office in paper format. The image format also prevents the documents from being accidentally modified or edited in most instances. In some embodiments, the patent documents in file history section 234 are also locked so that they cannot be edited or deleted by most users. As shown in FIG. 4, file history section 234 includes an html link 242 to an underlying Terminal Disclaimer paper that was filed in the Patent Office. Typically, section 234 would also include links to the filed patent application, declaration and oath papers and other documents—all stored in an image format. In some embodiments, only files stored in an image format are allowed to be displayed for access through section 234. Other embodiments, however, also allow for documents having other formats to be displayed in section 234. For example, an electronic filing receipt received from the USPTO in response to an electronic filing is typically received in an email message format. Such a “paper” is a document that was sent directly by a patent office and thus belongs in the file history section. While some embodiments will convert the document to an image format file for display in section 234, other embodiments will provide access to it in the format it was received through section 234.

Document section 236 lists files (referred to as “patent files” herein) associated with the selected patent application that were created by the applicant, the applicant's attorney or similar party. These patent files include documents such as invention disclosures that are not filed in a patent office as well as patent applications, responses to office actions and other documents that either were filed or are going to be filed in a patent office. Many of the patent files listed in document section 236 are stored locally on a client system or remotely on a server system, such as IP data processing system 100. The files may be stored in a format in which they are accessible, and editable if they are not locked, to the application program from which they were created or with which they are associated. Typically these files are stored in a format native to the associated application. For example, an invention disclosure, a patent application and a response to an office action that were all created by MS Word™ 2000 may all be stored in a .doc file. In other embodiments, however, it is possible to store these files in other formats such as text files (.txt) or compressed files (.zip) that are readily convertible to native file formats by the application program itself. For example, .txt files are readily convertible to .doc files by MS Word whereas a .pdf file of a scanned letter is not readily convertible to a .doc file since such a conversion requires optical character recognition (OCR) techniques.

Documents in section 236 may be organized in file folders. For example, one file folder 244 shown in FIG. 4 is entitled “filing package.” Filing package 244 may include a number of separate documents that are all part of a single patent filing, e.g., patent drawings associated with a drawing program such as ViSiO™, a patent specification associated with a word processor such as MS Word™ and various patent office forms, such as fee transmittal forms, information disclosure statement forms, etc. System 100 allows electronic access to both static and dynamic forms. Patent office forms may be stored in a variety of manners. For example, completed static forms may be stored in an image format (e.g., .pdf files) while for dynamic forms, the data associated with the form may be stored in a database. In the later case, when the user selects the form by clicking on its link to view the form, data processing system 100 can either generate the form for display to the user or display the data that is associated with fields of the form in some other format.

Case summary section 238 includes summary information about the particular patent application such as one or more of the invention's title, the list of inventors, the application filing date, the application number, list of countries the application was filed in, etc. In the embodiment illustrated in FIG. 4, a small subset of this information is displayed directly in section 238 (e.g., the title) and more detailed summary information can be accessed by selecting an information icon 246. Additionally, Web page 230 includes icons 232a, 234a and 236a that can be selected to display respective sections 232, 234 and 236 in a full page mode that displays more information than the approximately third of the screen each section takes up on page 230.

According to one embodiment, display sections 232, 234 and 236 each include multiple rows that each contain a file link to the correspondence, patent documents and patent files accessible through the sections. The sections may also contain multiple columns to display desired information. For example, a first column may contain an icon that indicates what type of document is associated with the file link (e.g., file folder or package, MS Word document, Visio document, email message, Web page, etc.), a second column may contain the file link, and a third column may include information such as the date a patent file was edited, the date a patent document or correspondence document was sent or received.

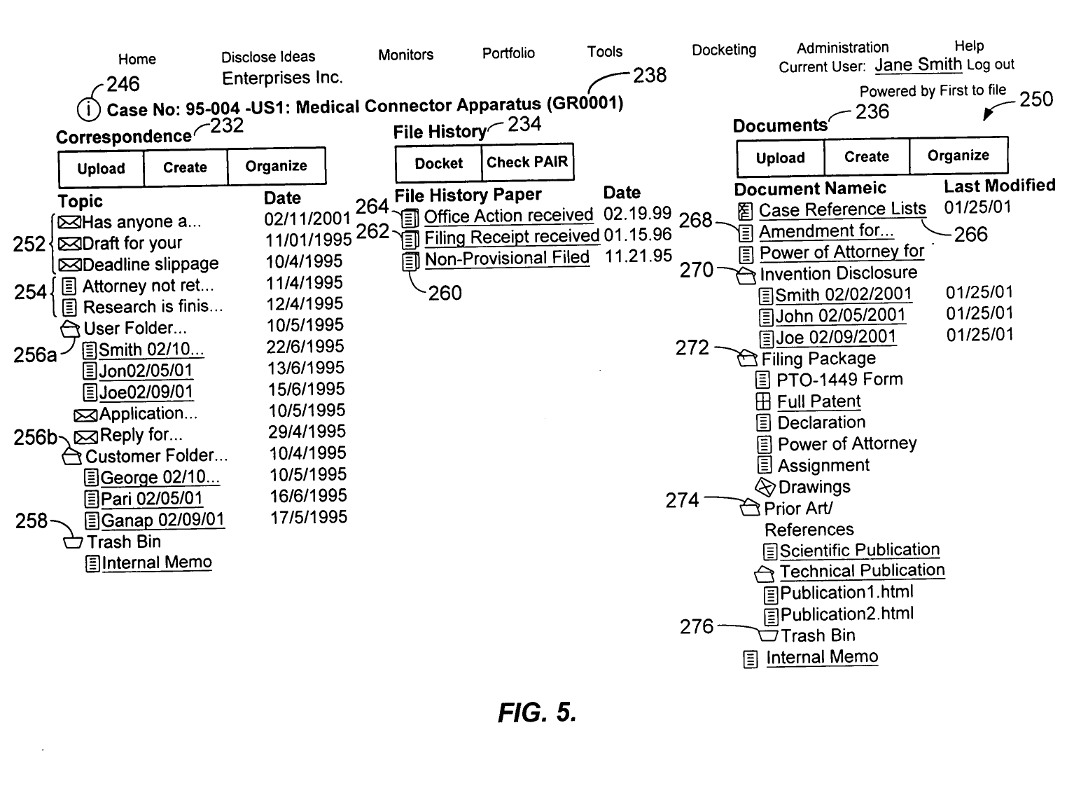

FIG. 5 is an example of a Web page 250 that shows another version of the trifold graphical user interface shown in FIG. 4 for a different data set. Note that while the format of trifold graphical user interface in FIG. 5 may seem different than that of FIG. 4 this is primarily due to different methods used to transfer the interface onto a printed page. As shown in FIG. 5, Web page 250 includes correspondence section 232, file history section 234, document section 236 and information section 238. Correspondence section 234 includes several email messages 252 and documents 254, e.g., MS Word™ files. It also includes folders 256a and 256b with each folder including additional documents. If desired, folders 256a and 256b can be created by a client system to organize and save documents, email messages, etc. that are related to a specific subject or issue that are pertinent only to certain client systems and thus are not viewable by others. For example, User Folder 256a may be user specific and include notes and emails the particular user desires to associate with the patent application for the user's records. Alternatively, folders can be created by users to organize and store documents and messages that are viewable by several different client systems as defined by the folder creator but not viewable to others who have access to other data of page 250. For example, a folder may organize documents viewable by all in-house client systems that have access to the patent application to track information related to an attorney working on the patent application that they may not want to share with either outside representative or inventor client systems. Section 232 also includes a trash bin 258 that stores deleted documents and messages until they are purged.

File history section 234 includes a patent application 260 and its associated documents that were filed in a patent office as well as a filing receipt 262 and first Office Action 264 that were received from the patent office. Each of the links 260, 262 and 264 actually represents a package of several documents with each individual document being stored in an image file format. Upon selecting the link, a Web page is displayed that shows the contents of the package and allows viewing access to the underlying documents. In this example, patent application package 260 was generated through IP data processing system 100 and filed electronically. Upon filing the application, an archived copy of each of the filed papers was created electronically in .pdf format and saved in section 234. Packages 262 and 264, on the other hand, were received at paper mailroom 108 and scanned into .pdf format. Once these documents were associated with case number 95-004-US1, links to the documents were automatically created for display in section 234. The lock displayed next to each of packages 260, 262 and 264 indicates that the documents contained in these packages are locked and therefore cannot be edited.

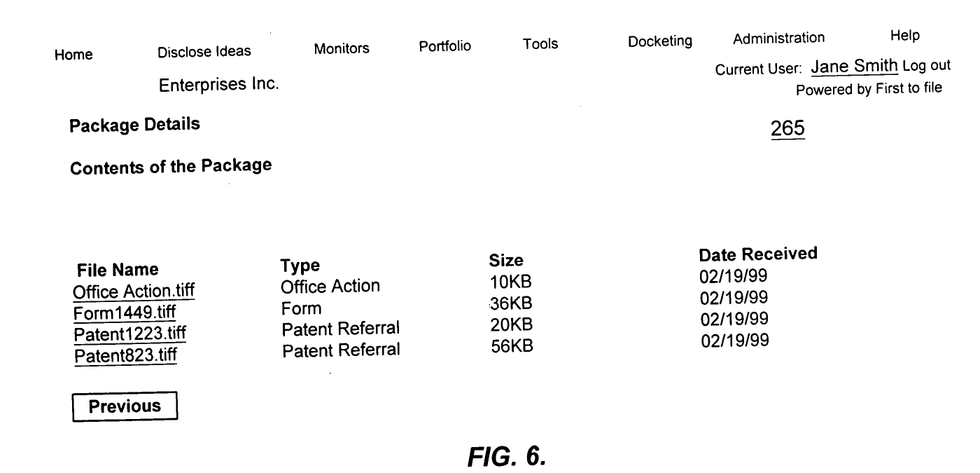

FIG. 6 is an example of a Web page 265 that shows the contents of office action package 264. As shown in FIG. 6, package 264 includes four different documents each stored in an image file format: a copy of the Office Action itself, a copy of a signed PTO-1449 form and copies of two different prior art patents that are referred to in the Office Action.

Document section 236 includes a list 266 of references cited in the case, an amendment 268 that is being prepared in response to the Office Action associated with link 264, a folder 270 that contains copies of several different versions of original invention disclosures for the patent application prepared by different inventors and a filing package folder 272 that contains documents filed in the patent office with the patent application. At least some of the documents in folder 272 correspond directly to the documents in patent application package 260. This is an important aspect of some embodiments of the invention. Both image format files and application format files for essentially the same document are accessible through different display sections of the interface. For example, as described above, if patent application package 260 includes the patent specification, the patent drawings, separate inventor oath and declaration forms, a power of attorney form, an assignment form and a transmittal form—each in an image file format, filing package folder 272 contains copies of these documents in their underlying native application format. That is, folder 272 contains a copy of the patent application in word processor format, a PTO-1449 form, separate declaration and power of attorney forms, an assignment form and patent drawings in either a format associated with a drawing program or a scanned format. Corresponding pairs of documents for responses to office actions and other papers created through system 100 and filed in a patent office will also exist between section 234 and 236 in other instances. Section 236 also includes a folder 274 that holds various prior art documents, e.g., the documents cited in the PTO-1449 form and a trash bin 276 that is similar to bin 258.

One feature provided in some embodiments of the present invention is that whenever an action is taken to create a document from the trifold graphical user interface, IP data processing system 100 automatically associates the created document with the patent application file shown on the trifold interface. For example, referring back to FIG. 4, document section 236 includes create and upload icons 280 and 282. Selecting upload icon 282 allows a client system to upload a document that was not originally created through IP data processing system 100 into the system. When the upload icon is selected from page 230, the uploaded document is automatically associated, e.g., in a database table, with Test Case 100-3 that trifold interface 230 provides access to. Similarly, create icon 280 allows the client system to initiate creation of a new document, such as a new patent application from an already filed invention disclosure or a new amendment after receiving an office action. When create icon 280 is selected, all fields that can be populated with data already in database 106 are so populated and the document is automatically associated with the case displayed in the user interface. The system will prompt the user for specific information for unpopulated fields or confirmation (and validation) of populated fields.

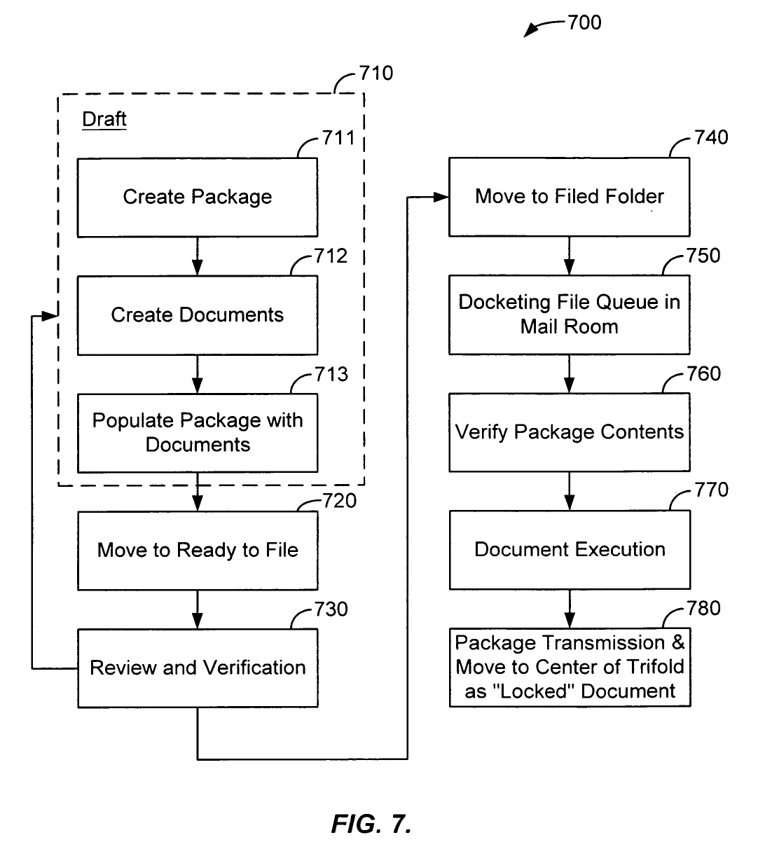

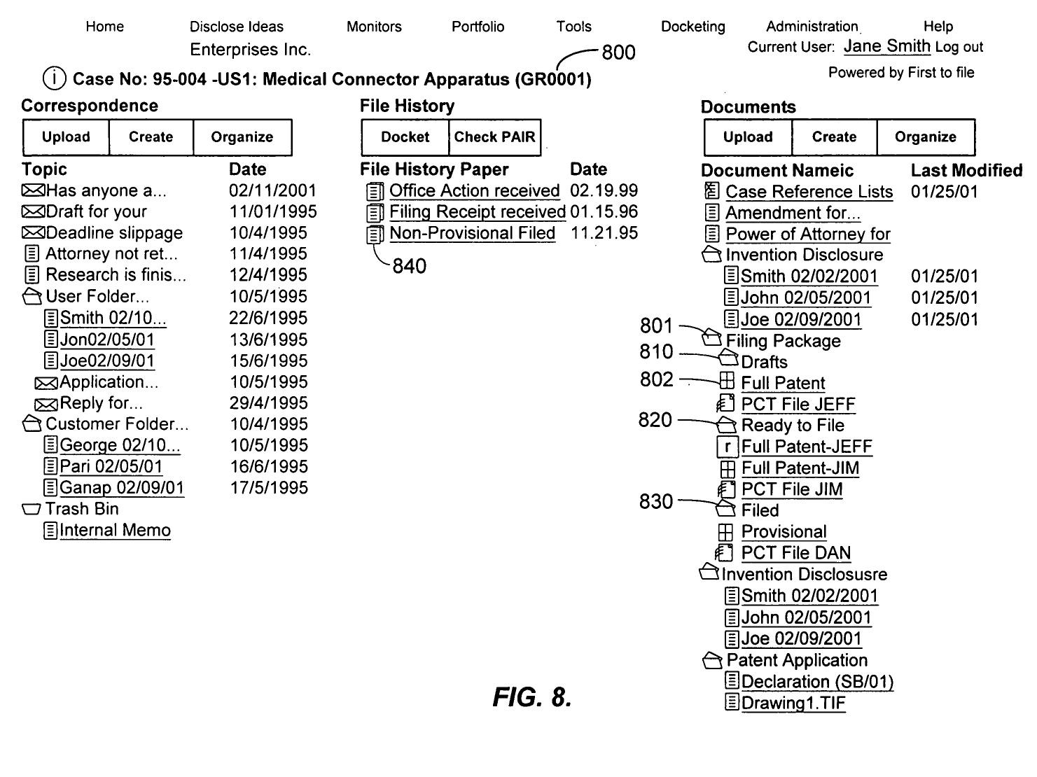

FIGS. 7 and 8 illustrate document edit control-functionality according to embodiments of the present invention. FIG. 7 shows a flow chart illustrating a computer-implemented method of controlling document edits 700, and FIG. 8 illustrates another exemplary Web page for controlling document edits in a trifold graphical user interface. Referring to FIG. 8, patent documents such as applications, invention disclosure statements, or office actions may be stored in the trifold documents section under filing package folder 801. Filing package folder 801 may include a draft folder 810, ready to file folder 820, and filed folder 830.

While the computer-implemented method of controlling document edits is described below with some references to IP data processing system 100 and/or the fold graphical user interface, it is to be understood that embodiments of the present invention may be utilized in other systems with other user interfaces. Generally, embodiments of the present invention provide document edit control by incorporating a computer controlled archival function that saves and locks all documents submitted to or received from patent offices so that they cannot be subsequently altered. An archival function may automatically “lock down” a document (i.e., the document is not capable of being edited) in response to a “lock signal” generated when the document passes between different phases of the document preparation and filing process. In one embodiment, a document preparation and filing process may include a final draft phase, a ready for filing phase, a filed phase, and a transmitted phase. When a document is in the final draft phase, the documents have been created and edited in their native applications and are ready for submission to a patent office. Documents in the final draft phase may be stored in the drafts folder 810, for example. In ready for filing phase, the documents may be reviewed and verified for quality control. Documents in the ready for filing phase may be stored in the ready for filing folder 820, for example. In the filed phase, documents may be placed in an outgoing mail queue for transmission (e.g., electronic or manual) to a patent office. Additionally, a second review and verification may take place to further enhance quality control. Documents in the filed phase may be stored in the filed folder 830, for example. The transmitted phase represents the point at which the documents have been electronically or manually transmitted to a patent office. Documents in the transmitted phase may be automatically moved to a file history section of a user interface, or equivalent, to keep a record of the documents actually submitted to a patent office, for example. Additionally, according to the present invention the documents in the file history section have been locked. Accordingly, as a user signals a computer system to move a document between phases, embodiments of the present invention lock down the document to ensure that inadvertent alterations are not introduced into the documents. It is to be understood, however, that other systems may include fewer or more phases in the document preparation process, which may also be represented by folders or other equivalent icons. For example, some systems may transition a document directly from final draft to filed, or from ready to file to transmitted. For another example, a confirmation step (e.g., a confirmation window having an electronic button) may be presented before a document is locked. Thus, an additional input signal may be required prior to locking the document. Accordingly, the present invention is not limited to locking down a document as it transitions between any of the particular phases described above.

In one embodiment, a lock signal is generated, and documents are locked automatically, when a user signals the system to move documents from a first position on a graphical user interface to a second position of a graphical user interface. For example, when a signal (e.g., click and drag) is received dragging a file from a first position to a second position in the graphical user interface, a “lock signal” may be generated to automatically lock down one or more documents. The first and second positions on the graphical user interface may, for example, correspond to two different phases of the document preparation process. In other embodiments, the “lock signal” may be generated in response to a signal indicating that the documents are to be transmitted to a patent office. For example, a signal such as a mouse-click on a “File Patent Application” button, pull down menu, or equivalent, to transmit a patent application and related documents to a patent office, may also generate a lock signal for automatically locking down the documents. In one embodiment, locking electronic documents may be implemented by automatically modifying attributes associated with the electronic document. In another embodiment, locking may be implemented by automatically reformatting the electronic document type from a editable document type to a non-editable document type.

In one particular embodiment, a method of controlling document edits 700 may begin in a draft phase 710 by creating a package at step 711 for containing the documents to be filed in the patent office. A package is a logical grouping of electronic documents to be sent to a patent office that is represented graphically by a single icon. Electronic documents may be linked to a particular package by pointers or attributes associated with the package. It is to be understood, however, that a variety of well-known programming techniques could be employed to implement the package concept. At 712 the documents to be entered into tie package are created. For instance, a non-provisional patent application and associated filing forms may be generated in filing package folder 801 at step 712. It is to be understood that the electronic documents associated with a non-provisional patent application may be formatted in a variety of format types (e.g., .doc, .txt, .pdf, etc.). Documents may also be selected from different portions of the document section of the trifold, and may be moved or copied into the draft folder 810. In the trifold of FIG. 8, documents and packages created in the draft phase 710 are stored in the draft folder 810. At step 713 the documents are entered into a single package for filing in a patent office as a complete patent filing 802 (e.g., a complete patent application with all supporting documents).

After final drafts of the documents to be submitted to the patent office are placed in a package, the final draft package may be moved from draft folder 810 to ready to file folder 820 at ready to file phase 720. Once in the ready to file folder 820, a review and verification step 730 may be performed during the ready to file phase. Review and verification step 730 may include an examination of the package by, for example, a patent agent or attorney for completeness or for errors. In one embodiment, a lock signal is generated, and the documents in the package are automatically locked, when the package is moved from draft folder 810 to the ready to file folder 820. If the reviewing entity discovers an error or omission, the package may be returned to the draft folder 810, and method 700 returns to the draft phase 710. If the package is returned to the draft folder 810, the documents may automatically be unlocked. However, if the reviewing entity approves the package, the package is moved to the filed folder 830 at step 740. In some embodiments of the present invention, the ready to file folder 820 and move to ready to file step 720 may be omitted. In such a case, final draft documents are locked when moved to the filed folder 830. Accordingly, both the lock signal generation and the review and verification step 730 would be associated with the filed folder 830 and move to filed folder step 740.

When the package is placed in the filed folder 830 at move to filed phase 740, the package may also be placed in an outgoing docketing file queue in a mail room of the IP data processing system at step 750. At step 760, a second quality control verification of the package contents may optionally be performed. For example, in one embodiment, the documents may be reviewed by a patent paralegal or other patent specialist to ensure that all of the USPTO requirements for submitting a non-provisional application have been met. At step 770, the documents may be executed. For example, in one embodiment, the documents in the package are printed, signed, scanned, and uploaded as image files. Of course, the present invention contemplates that in the future electronic signatures may be available, thus rendering written signatures unnecessary in certain circumstances. Therefore, in another embodiment, the document execution may be performed by the attorney or agent at the time of review and verification step 830.

In one embodiment, a user may include a document stored locally on a client system as part of a package on a remote server system. Locally stored documents may be stored on a local drive, network drive, or in a document management system. When the system locks the documents in the package, the system will automatically load the locally stored document onto the server prior to locking. Accordingly, users may conveniently prepare draft documents offline, and perform the packaging and filing when the documents are in final draft form.

Once the documents in the package that require signatures have been executed, the document may be either electronically or manually filed in the patent office. Accordingly, the package is transmitted to the patent office at step 780. Transmission of the package automatically triggers a second lock down signal, and each of the documents in the filing package is automatically converted from their original document format types to locked image files (e.g., locked .pdf). Additionally, the system to moves the package of locked image files from the filed folder 830 to the “File History” section of the trifold. Accordingly, the system maintains an accurate unalterable record of the documents formally submitted to the patent office.

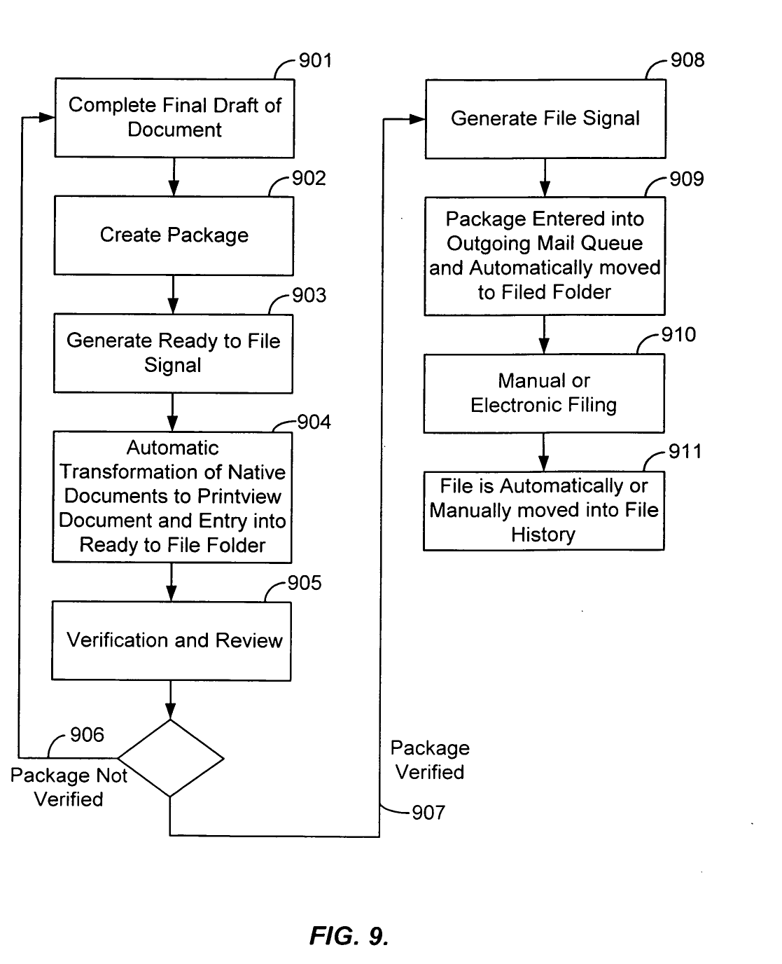

Embodiments of the present invention are particularly advantageous in applications using a distributed filing model exemplified by IP data processing system 100 discussed above. One problem faced by such system is that the person performing review and verification of a package before filing (e.g., a patent attorney or agent), must be certain that the documents review are the same as the documents actually filed. However, for remote IP data processing systems, the reviewing and verifying entity is not directly involved in the submission process, other than transmitting a remote signal indicating that the documents are to be filed. Therefore, FIG. 9 illustrates a method of controlling document edits according to one embodiment of the present invention that ensures documents in the package, as reviewed, are the same as the documents submitted to a patent office. At step 901, documents are edited, and final drafts are completed. At step 902, a package may be created. At step 903, a user generates a signal indicating that the package is ready to be filed (e.g., via an electronic “Ready to File” button, menu item, or equivalent). In response to the ready to file signal, the system may automatically transform the electronic documents in the package from their native format types into a document type that has the property of being viewable (i.e., displayed to a user) exactly as it will be printed at 904. Document types with this property are referred to herein as “printview type” documents. One example of such a document type is a .pdf document. However, other document types having this property may also be used. Additionally, the system may optionally move the package into a ready to file folder, if a graphical user interface similar to the one discussed above is used.

Transforming the documents in the package from their native format types to a document type that can be viewed exactly as it will be printed allows the reviewing and verifying entities to be certain that the documents they are reviewing and verifying will be printed exactly as reviewed. The “printview type” documents are reviewed and verified at step 905. Review and verification may be done remotely in a distributed filing system such as IP data processing system 100. If a document in the package contains an error or inaccuracy, then the package is not verified at 906, and the user may generate a signal indicating that the package is to be returned for editing (e.g., via an electronic “Return to Draft” button, menu item, or equivalent). In such a case, the documents in the package may be automatically transformed back into their native format type for further editing at step 901. However, if a document in the package is correct and without discovered errors, then the package is verified at 907, and the user may generate a signal indicating that the package can be filed (e.g., via an electronic “File” button, menu item, or equivalent). At step 909, the package is entered into an outgoing mail queue. Additionally, the system may optionally move the package into a filed folder, if a graphical user interface similar to the one discussed above is used. At step 910, the package may be manually printed and filed in a patent office or electronically filed in a patent office. At step 911, the file may be manually or automatically associated with other documents in the file history of the particular case to which the package is related. For example, the system may optionally move the package into a file history section of a graphical user interface, if a graphical user interface similar to the one discussed above is used.

These and other embodiments as well as alternatives and equivalents to the invention will be recognizable to those of skill in the art after reading the description of the present invention. The scope of the invention should not, therefore, be determined solely by reference to the above description, but instead should be determined with reference to the appended claims along with their full scope of equivalents and alternatives.

What is claimed is:

1. A computer-implemented method of controlling document edits comprising:
storing a plurality of alterable electronic documents on a computer system, the plurality of electronic documents being associated with a patent application;
generating a first signal indicating that one or more of the electronic documents are to be filed in a patent office; and
automatically locking the one or more electronic document into a non-editable form.

2. The method of claim 1 further comprising storing the one or more electronic documents in a package prior to generating the first signal.

3. The method of claim 1 further comprising performing a manual verification of the locked electronic documents prior to filing the documents in the patent office.

4. The method of claim 1 further comprising electronically transmitting the electronic documents to the patent office.

5. The method of claim 1 further comprising generating a first lock signal in response to the first signal, and in accordance therewith, automatically locking the one or more electronic documents.

6. The method of claim 5 wherein the automatically locking includes automatically converting the one or more electronic documents from a first document type to a locked image file.

7. The method of claim 6 further comprising displaying the locked image files in a file history portion of a graphical user interface.

8. The method of claim 6 wherein the locked image file is a locked .pdf file.

9. The method of claim 1 further comprising generating a second signal indicating that the one or more of the electronic documents are final draft documents.

10. The method of claim 9 wherein each electronic document has a native format type, the method further comprising generating a first lock signal in response to the second signal, and in accordance therewith, automatically locking the one or more electronic documents in their native format types, and generating a second lock signal in response to the first signal, and in accordance therewith, automatically converting the one or more electronic documents from their native format types to locked image files.

11. The method of claim 1 wherein the electronic documents include a provisional patent application specification, non-provisional patent application specification, response to an office action, inventor declaration, assignment, power of attorney, or patent drawings.

12. A computer-implemented method of controlling document edits comprising:
storing a plurality of alterable electronic documents on a computer system, the plurality of electronic documents being associated with a patent application;
creating a package including one or more of the electronic documents, the package being displayed in a first folder of a graphical user interface; and
automatically locking down the one or more electronic documents in the package when a user transmits a first signal indicating that the package has been transferred from a first phase to a second phase.

13. The method of claim 12 wherein the first phase is a final draft phase and the second phase is a ready to file phase.

14. The method of claim 12 wherein the first phase is a final draft phase and the second phase is a filed phase.

15. The method of claim 12 wherein the first phase is a filed phase and the second phase is a transmitted phase.

16. The method of claim 12 wherein automatically locking includes automatically converting the one or more electronic documents from a first document type to a locked image file.

17. The method of claim 16 further comprising displaying the locked image files in a file history portion of a graphical user interface.

18. The method of claim 12 wherein the each electronic document has a native format type, the method further comprising generating a first lock signal in response to the first signal, and in accordance therewith, automatically locking the one or more electronic documents in their native format types, and generating a second lock signal in response to a second signal indicating the package has been transferred from the second phase to a third phase, and in accordance therewith, automatically converting the one or more electronic documents from their native format types to locked image files.

19. The method of claim 12 wherein the electronic documents include a provisional patent application specification, non-provisional patent application specification, response to an office action, inventor declaration, assignment, power of attorney, or patent drawings.

20. A computer-implemented method of controlling document edits comprising:
storing a plurality of electronic documents on a computer system, each electronic document having a native format type;
creating a package including one or more of the electronic documents;
generating a first signal indicating that package is ready to be filed in a patent office;
automatically transforming the one or more electronic documents from its native format types into a format type that is viewable as it will be printed; and
displaying the transformed one or more electronic documents to a remote user.

21. The method of claim 20 further comprising locking the transformed one or more documents.

22. The method of claim 20 further comprising generating a signal indicating that the package can be filed.

23. The method of claim 22 further comprising entering the package into an outgoing mail queue.

24. The method of claim 23 further comprising electronically filing the package in a patent office.
